(19) United States
(12) Patent Application Publication
(10) Pub. No.: US 2015/0285323 A1
(43) Pub. Date: Oct. 8, 2015

(54) CALIPER DISC BRAKE AND ACTUATING DEVICE THEREFOR

(71) Applicant: WABCO Europe BVBA, Brussels (BE)

(72) Inventor: Hans-Christian JUNGMANN, Gorxheimertal (DE)

(21) Appl. No.: 14/672,953

(22) Filed: Mar. 30, 2015

(30) Foreign Application Priority Data
Apr. 3, 2014 (DE) 10 2014 004 905.1

(51) Int. Cl. F16D 65/18; F16D 65/00

(52) U.S. Cl. CPC F16D 65/18; F16D 65/0068; F16D 2125/08

(57) ABSTRACT

A caliper disc brake includes a brake caliper (10) having a first flange face (14) in a first flange plane, an actuating device (12) having a second flange face (16) in a second flange plane which bears against the first flange face, and a seal (22) which, in the attached state, bears on a first side against a first sealing face located (18) on the brake caliper and facing the actuating device, and bears on a second side against a second sealing face (20) on the actuating device. The second sealing face (20) is located opposite the first sealing face and faces the brake caliper. The second sealing face (20) is offset by a spacing (A) from the second flange plane of the second flange face (16). The spacing (A) is formed by a step between the second flange face (16) and the second sealing face (20).

### TECHNICAL FIELD

The invention relates to a caliper disc brake comprising a brake caliper having a first flange face, an actuating device having a second flange face bearing against the first flange face in the flange-connected state, and a seal which, in an attached state, bears on one side against a first sealing face on the brake caliper facing the actuating device, and which on the other side bears against a second sealing face on the actuating device, the second sealing face being disposed opposite the first sealing face with regard to the seal and facing the brake caliper.

Furthermore, the invention relates to an actuating device of a caliper disc brake of this type.

### BACKGROUND

Caliper disc brakes of the abovementioned type are known. In these devices, the first and the second sealing face delimit a space, into which the seal extends. Here, the seal runs around a functional opening of the actuating device or the brake caliper, through which a plunger of the actuating device extends from the actuating device into the caliper interior.

Since that space, into which the seal extends, is delimited on one side by a sealing face on the brake caliper and on the other side by a sealing face on the actuating device, the space lies at the interface between the brake caliper and the actuating device.

The first sealing face adjoins the first flange face. The two sealing faces are annular and lie within the flange faces which are likewise of annular configuration.

The two flange faces are planar. The sealing faces are usually likewise substantially planar.

In the known caliper disc brakes, the first sealing face is arranged on the caliper at a spacing from the plane of the first flange face in order to form that space, into which the seal extends. In other words, the first sealing face is recessed with regard to the first flange face. It forms a shoulder.

Corresponding working steps are required during the production of the brake caliper in order to form the shoulder. The working steps signify extra time and cost. The brake caliper which is usually composed of cast iron has to be reworked in a suitable way.

### SUMMARY OF THE INVENTION

The invention is based on the object of improving the caliper disc brake of the type mentioned at the outset, in such a way that the production outlay is reduced.

According to a first aspect of the invention, the object is achieved by virtue of the fact that the second sealing face is arranged on the actuating device at a spacing from the plane of the second flange face.

This feature is based on the finding that, as a result of the arrangement of the second sealing face at a spacing from the plane of the second flange face, the above-described space, into which the seal extends, between the caliper on one side and the actuating device on the other side can be produced even when the first sealing face lies in the same plane as the first flange face. As a result, the complicated reworking of the brake caliper can be dispensed with, which considerably reduces the production outlay. The arrangement of the second sealing face at a spacing from the plane of the second flange face is associated only at low expense, because the side of the actuating device facing the brake caliper is made from a material that can be correspondingly shaped more easily than cast iron.

Here, it is preferred according to another aspect of the invention that the first and/or the second sealing face are/is annular, in particular circularly annular.

Furthermore, it is further preferred that the seal is annular, in particular circularly annular, at least in so far as it extends into the space between the brake caliper and the actuating device.

As has already been mentioned above, it is preferably provided according to a further aspect of the invention that the seal seals a functional opening of the brake caliper and/or a functional opening of the actuating device.

According to a further preferred embodiment of the invention, a step is provided between the second flange face and the second sealing face. This is particularly advantageous because the second sealing face is adjacent to the second flange face.

According to yet another aspect of the invention, the actuating device can be configured in principle in any desired manner. However, it is considered particularly advantageous that at least that part of the actuating device which has the second flange face and the second sealing face has a deep-drawn part. A deep-drawn part can be configured with particularly low outlay in such a way that the second sealing face is arranged at a spacing from the plane of the second flange face.

According to the another aspect of the invention, the second flange face and/or the second sealing face are/is further preferably configured on a housing of the actuating device. The housing can then in turn be configured in such a way that it is particularly simple to arrange the second sealing face at a spacing from the plane of the second flange face. It can thus be, for example, a deep-drawn part.

According to a further aspect of the invention, the spacing of the second sealing face from the plane of the second flange face preferably lies in the range from 1 mm to 6 mm, further preferably in the range from 2 mm to 4 mm, in one specific exemplary embodiment at 3 mm.

According to yet another aspect of the invention, the first flange face and the first sealing face further preferably lie in the same plane. As a result, no working in this regard of the brake caliper is required.

According to a further aspect of the invention, the actuating device can be configured in principle in any desired manner. It preferably operates with compressed air.

In addition to the above-described caliper disc brake, the disclosure also provides an actuating device of a caliper disc brake of this type, that is to say an actuating device, in which the second sealing face is arranged at a spacing from the plane of the second flange face.

In the following text, the various aspects of the invention are explained in greater detail with further specifics using one preferred exemplary embodiment with reference to the appended drawings. The drawings are provided merely for illustrative purposes and are not intended to limit the scope of the present invention.

### BRIEF DESCRIPTION OF THE DRAWINGS

In the drawings,

FIG. 1 shows a diagrammatic sectional view of a conventional caliper disc brake,

FIG. 2 shows the same view as FIG. 1, but of one exemplary embodiment of the invention,

FIG. 3 shows a diagrammatic perspective view of the actuating device of the caliper disc brake according to FIG. 2, before the seal is mounted, and

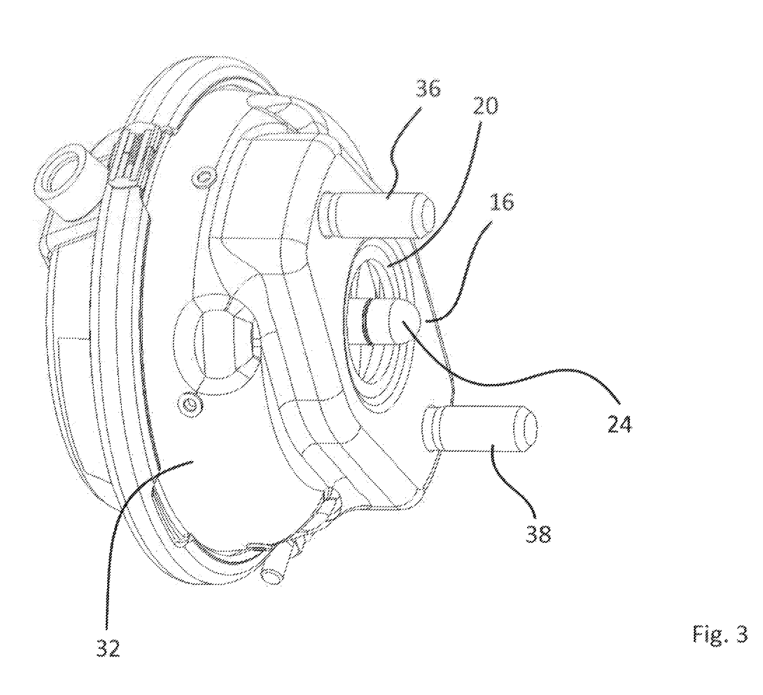

FIG. 4 shows the same view as FIG. 3, but with the seal mounted.

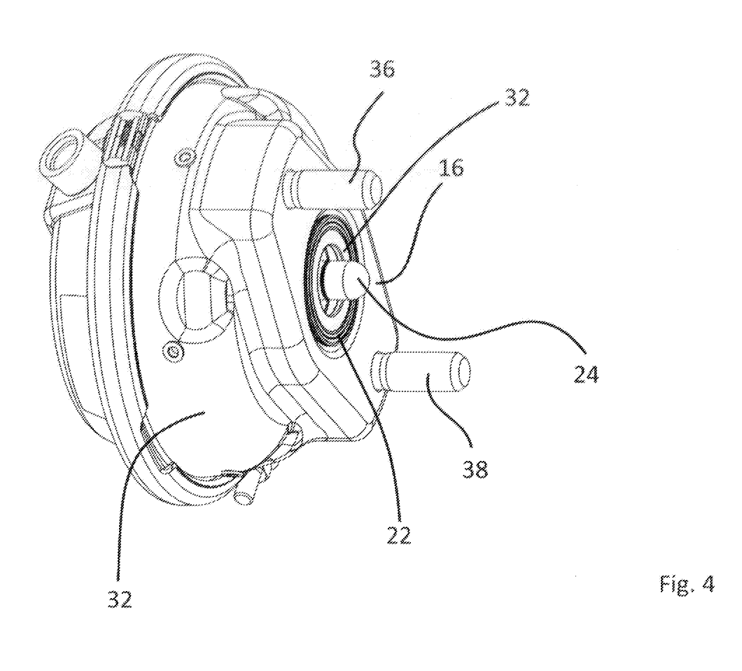

### DETAILED DESCRIPTION OF THE DRAWINGS

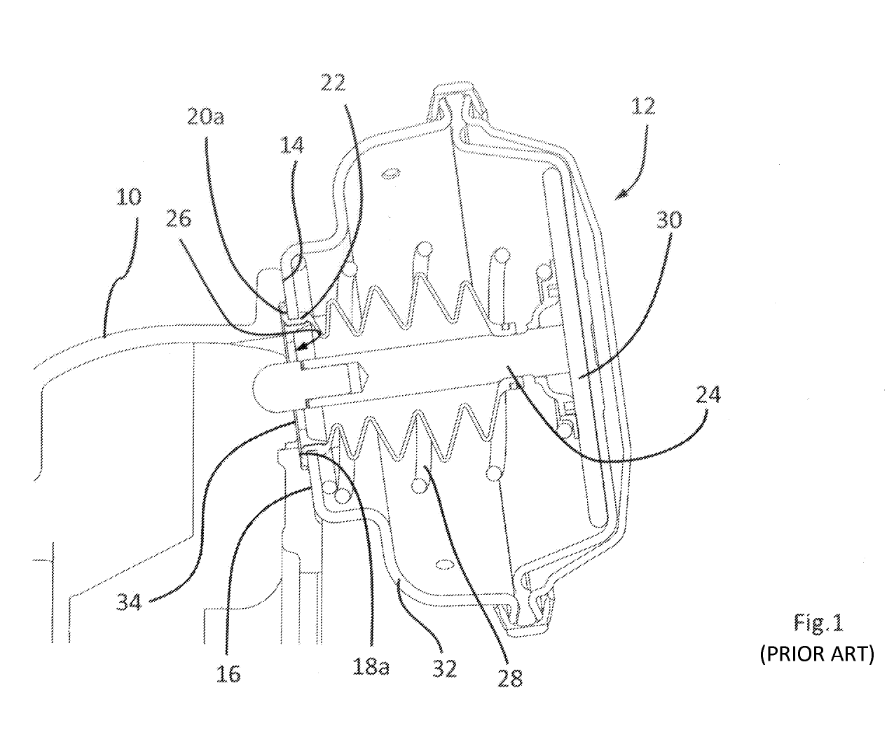

Part of the known caliper disc brake according to FIG. 1 is a brake caliper 10, to which an actuating device 12 is flange-connected. To this end, a second flange face 16 of the actuating device 12 bears against the first flange face 14 of the brake caliper 10. A first sealing face 18a of the brake caliper 10 lies adjacently with respect to the first flange face 14 of the brake caliper 10. In the same way, a second sealing face 20a of the actuating device 12 lies adjacently with respect to the second flange face 16 of the actuating device 12. Part of a seal 22 is situated in the annular space which lies between the first and the second sealing face 18a and 20a. The seal 22 serves to seal a pneumatically actuated plunger 24 of the actuating device 12 from the surroundings, which plunger 24 extends through a functional opening 26 into the interior of the brake caliper 10. A spring 28 serves to bias a pressure plate 30 which is actuated by means of the abovementioned pneumatic system.

In the conventional caliper disc brake according to FIG. 1, the second flange face 16 lies in one plane with the second sealing face 20a of the actuating device 12, whereas the first sealing face 18a of the brake caliper 10 is recessed with regard to its first flange face 14, for which reason the first and the second sealing face 18a and 20a lie in different planes as a result and produce a space in this way for receiving the seal 22.

In order for the first sealing face 18a of the brake caliper 10 to be recessed with regard to the first flange face 14, the second flange face 16 and the second sealing face 20a, special working of the brake caliper 10 which is composed of cast iron material is required, for example milling. This is associated with considerable outlay.

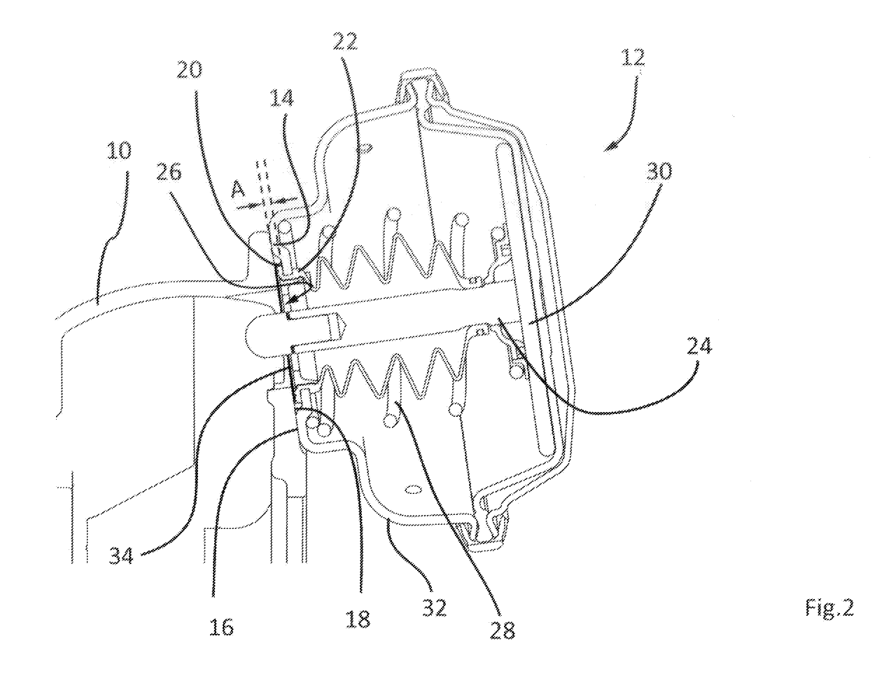

This is different in the exemplary embodiment of the invention which is shown in FIG. 2 and has a first sealing face 18 on the brake caliper 10 and a second sealing face 20 on the actuating device 12: there, the second sealing face 20 of the actuating device 12 is recessed with regard to its second flange face 16. In other words, the plane of the second sealing face 20 is arranged at a spacing with regard to the plane of the second flange face 16. In the exemplary embodiment which is shown, the spacing A is 3 mm. As a result, a space for receiving the seal 22 is produced, without it being necessary to arrange the first sealing face 18 of the brake caliper 10 in a different plane than the first flange face 14. In other words, corresponding reworking of the brake caliper 20, for example by way of milling, is not required.

Unlike in the case of the brake caliper 10, it is relatively simple to bring about the recessed plane for forming the receiving space for the seal 22 in the case of the second sealing face 20 with regard to the second flange face 16 of the actuating device 12. The housing 32 of the actuating device 12 is a deep-drawn part, into which only a corresponding shoulder with the dimension A has to be stamped.

A holder 34 serves for the radial bias of the seal 22 in the region of the second sealing face 20.

Fastening bolts 36, 38 serve to fasten the actuating device 12 to the brake caliper 10.

The features of the invention which are disclosed in the above description, the claims and the drawing can be essential both individually and in any desired combinations for the realization of the invention in its different embodiments.

What is claims is:

1. A caliper disc brake comprising
a brake caliper (10) having a first flange face (14) in a first flange plane,
an actuating device (12) having a second flange face (16) in a second flange plane which bears against the first flange face in an attached state, and
a seal (22) which, in the attached state, bears on a first side against a first sealing face located (18) on the brake caliper and facing the actuating device, and bears on a second side against a second sealing face (20) on the actuating device, the second sealing face (20) being located opposite the first sealing face with respect to the seal and facing the brake caliper,
wherein the second sealing face (20) is offset by a spacing (A) from the second flange plane of the second flange face (16).

2. The caliper disc brake as claimed in claim 1, wherein at least one of the first sealing face (18) and the second sealing face (20) is annular.

3. The caliper disc brake as claimed in claim 1, wherein the seal (22) is annular.

4. The caliper disc brake as claimed in claim 1, wherein the seal (22) seals a circumference of a functional opening (26) in at least one of the brake caliper (10) and the actuating device (12).

5. The caliper disc brake as claimed in in claim 1, further comprising a step between the second flange face (16) and the second sealing face (20).

6. The caliper disc brake as claimed in clam 1, wherein at least a part (32) of the actuating device (12) bearing the second flange face (16) and the second sealing face (20) is a deep-drawn part.

7. The caliper disc brake as claimed in claim 1, wherein at least one of the second flange face (16) and the second sealing face (20) is formed on a housing (32) of the actuating device.

8. The caliper disc brake as claimed in claim 1, wherein the spacing (A) of the second sealing face (20) from the second flange plane of the second flange face (16) lies in a range from 1 mm through 6 mm, preferably in the range from 2 mm to 4 mm, more preferably at 3 mm.

9. The caliper disc brake as claimed in claim 8, wherein the spacing (A) lies preferably in a range from 2 mm through 4 mm.

10. The caliper disc brake as claimed in claim 9, wherein the spacing (A) amounts to 3 mm.

11. The caliper disc brake as claimed in claim 1, wherein the both first flange face (14) and the first sealing face (18) lie in the first flange plane.

12. The caliper disc brake as claimed in claim 1, wherein the actuating device (12) operates with compressed air.

13. An actuating device of a caliper disc brake, comprising an actuator flange face (16) in an actuator flange plane and an actuator sealing face (20) offset by a spacing (A) from the actuator flange plane of the actuator flange face (16).

14. The actuating device as claimed in claim 13, wherein the actuator sealing face (20) is annular.

15. The actuating device as claimed in in claim 13, further comprising a step between the actuator flange face (16) and the actuator sealing face (20).

16. The actuating device as claimed in claim 13, wherein the spacing (A) of the actuator sealing face (20) from the actuator flange plane of the actuator flange face (16) lies in a range from 1 mm through 6 mm, preferably in the range from 2 mm to 4 mm, more preferably at 3 mm.

17. The actuating device as claimed in claim 16, wherein the spacing (A) lies preferably in a range from 2 mm through 4 mm.

18. The actuating device as claimed in claim 17, wherein the spacing (A) amounts to 3 mm.

19. The actuating device as claimed in claim 13, wherein the actuating device (12) operates with compressed air.
